(19) United States
(12) Patent Application Publication
(10) Pub. No.: US 2005/0194543 A1
(43) Pub. Date: Sep. 8, 2005

(54) Methods and apparatus for controlling ion current in an ion transmission device

(75) Inventor: Andreas Hieke, Cupertino, CA (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: Ciphergen Biosystems, Inc., Fremont, CA (US)

(21) Appl. No.: 11/063,801

(22) Filed: Feb. 22, 2005

Related U.S. Application Data
(60) Provisional application No. 60/547,302, filed on Feb. 23, 2004.
(60) Provisional application No. 60/619,113, filed on Oct. 15, 2004.

(51) Int. Cl. H01J 3/14

(52) U.S. Cl. 250/400

(57) ABSTRACT

The invention provides apparatus and methods for controlling ion current in an ion transmission device. An apparatus of the present invention comprises an ion source, an ion transmission device, and a controller. The ion source and the ion transmission device are in ion communication therebetween, and the controller is in signal communication with both the ion source and the ion transmission device. The ion current of the ion transmission device may be controlled by coordinating at least one of the operating parameter values of the ion source with at least one of the operating parameter values of the ion transmission device. Such coordination may result in, for example, improved ion current in the ion transmission device. Also embraced by the present invention are mass spectrometer embodiments that include or use the apparatus or methods of the present invention for controlling ion current.

### CROSS-REFERENCE TO RELATED APPLICATIONS

This application claims the benefit of U.S. provisional patent applications Ser. No. 60/547,302, filed Feb.23, 2004, and Ser. No. 60/619,113, filed Oct. 15, 2004, the disclosures of which are incorporated herein by reference in their entireties.

### FIELD OF THE INVENTION

This invention is in the field of chemical and biochemical analysis, and relates particularly to methods and apparatus for controlling and improving ion current in an ion transmission device in a mass spectrometer apparatus.

### BACKGROUND OF THE INVENTION

From its development in the late nineteenth century, mass spectrometry has become an increasingly powerful tool for the analysis of molecular matter. In its simplest form, all mass spectrometers contain certain necessary components. First, an ion source is needed in which volatile ions are generated from the original sample. Second, a mass analyzer resolves the ionic population generated from the sample by virtue of their relative mass-to-charge ratios. Finally, a detector is required to detect and measure the signal from the resolved ions to yield the desired output.

Mass spectrometry has been successfully used to characterize and identify a wide variety of species, ranging from purified natural products to complex mixtures of protein extracts. Moreover, more recent developments have extended the range of masses that can now be analyzed by mass spectrometry. For example, the characterization of large molecular weight biopolymers by mass spectrometry, such as proteins and nucleic acids, is now a matter of routine.

Despite these improvements, certain limitations of the technique still remain. Among the most significant of these limitations relates to the sensitivity of mass spectrometer. Poor sensitivity results in the inability to obtain a discernible, identifiable signal from the sample. This problem is particularly apparent when studying large biomolecules such as proteins, because of the difficulty of obtaining such samples in sufficient molar quantities.

Although sensitivity can be improved by obtaining larger quantities of the desired sample, sensitivity can also be hampered by certain shortcomings of the mass spectrometer apparatus itself. For example, ions generated from the sample in the ion source need to be conducted to subsequent components, such as mass analyzers, mass filters, and ion guides. This flux of ions, also known as the ion current, is primarily governed by static and dynamic electric fields that can accelerate and deflect the sample ions. These electric fields are generated by electrodes to which appropriate potentials are applied. For example, ions generated in the ion source can be extracted by an electric field generated by electrodes. Similarly, ions are conducted through other components, such as mass filters or ion guides, by the application of alternating current (AC) voltages on the electrodes, thereby generating a dynamic electric field suitable for ion transmission through the component.

The shortcoming of the above is that the ion current, and hence the yield of ion transmission, is in many cases mass-dependent. In other words, applying a given set of electric potentials to the electrodes responsible for inducing an ion current will not conduct all ionic masses with equal efficiency. Instead, a subset of ion masses are conducted with higher efficiency for a given set of electrode parameters. This limitation is particularly deleterious to the mass spectrometry of large molecules, such as proteins and other biological extracts. Such samples can be composed of complex mixtures of molecules, including large molecular weight molecules. Ionization of these samples by the ion source may result in a diverse population of ions having a range of masses that can extend over one or more orders of magnitude.

Current methods to remedy this mass-dependency of ion transmission, thereby increasing the overall sensitivity of the mass spectrometer have been neither adequate nor practical. As an example, one such solution is to adjust, or “ramp”, the parameters applied to a given component of the apparatus, such as a radio-frequency multipole ion guide. By ramping the parameters of the RF multipole ion guide, different sets of AC potentials are applied to the electrodes of the ion guide, in which each set corresponds to a different mass range that is more efficiently transmitted through the component. The spectrometric data resulting from each ramp level can be separately collected and later recomposited. Although this strategy may result cumulatively in the appearance of ion transmission over a wider range of masses, the improvement is only local to the ion guide.

The overall sensitivity of the apparatus is a function of the ion current throughout the entire apparatus, and not just one component. As a result, sensitivity may not be improved by ramping any given component, because of the components that precede or follow the ramped component. These other components may not be configured to provide or to accept the same range of ionic masses, thereby resulting in a overall loss of ion current. Currently known apparatus and methods for mass spectrometry are not suited to address this problem of disjunction of ion transmission between sequential components within a mass spectrometer.

Accordingly, it is desirable to provide apparatus and methods for improving the sensitivity of mass spectrometric analysis over a broader range of masses.

It is further desirable to provide apparatus and methods for configuring or modifying a mass spectrometer in order to control the ion current of an ion transmission device therein.

### SUMMARY OF THE INVENTION

The present invention solves these and other needs by providing an apparatus with an ion source and an ion transmission device, wherein the ion source and the ion transmission device are in ion communication. The ion current of the ion source may be controlled by coordination of the operating parameters of the ion source with the operating parameters of the ion transmission device.

In a first aspect, the present invention provides a method for controlling the ion current of an ion transmission device by coordinating the respective operating parameters of the ion transmission device with the ion source.

In another aspect, a method of the present invention is a method for controlling the ion current of an ion transmission device, wherein an ion source is in ion communication with and provides ions to the ion transmission device, the method comprises coordinating a value for each of at least one operating parameter of the ion source with a value for each of at least one operating parameter of the ion transmission device.

The step of coordinating may include setting the ion source operating parameters with values that are predetermined, or selected from a set of predetermined values. The predetermined values for the ion source operating parameters may be predetermined for providing ions of a given mass range from the ion source to the ion transmission device. The predetermined values for the ion source operating parameters may also be predetermined to provide ions of all mass ranges from the ion source to the ion transmission device.

In certain embodiments, an apparatus of the present invention or methods practiced therewith may include an ion transmission device that provides ions to a mass spectrometer, an ion mobility spectrometer, or a total ion current measuring device.

In certain embodiments, the step of coordinating comprises setting values of the ion transmission device operating parameters and the ion source operating parameters, wherein the both of the respective values are predetermined for the given mass range of ions.

In certain embodiments, the step of coordinating comprises setting a first set of values of the ion transmission device operating parameters and setting a first set of values of the ion source operating parameters, wherein said first set of values for the ion source are predetermined based on the first set of values of the ion transmission device operating parameters. In certain embodiments, this method may further comprise the steps of setting a second set of values of the ion transmission device operating parameters and setting a second set of values of the ion source operating parameters, wherein said second set of values for the ion source are predetermined based on the second set of values of the ion transmission device operating parameters.

In certain embodiments, the step of coordinating comprises determining the values of the ion transmission device operating parameters and then setting values of the ion source operating parameters, wherein said values for the ion source are predetermined based on the values determined for the ion transmission device operating parameters.

In certain embodiments, an apparatus of the present invention or methods practiced therewith may include an ion transmission device that comprises a multipole radio-frequency ion guide. In such embodiments, examples of ion transmission device operating parameters include the amplitude and frequency of the alternating current potential of the multipole ion guide electrodes. Ion transmission device operating parameters may also include the amount of DC potential that may be applied to the multipole radio-frequency ion guide with the AC potential. In certain embodiments, an apparatus of the present invention or methods practiced therewith may include an ion transmission device that comprises an electrostatic ion guide or an electromagnetic ion guide.

In certain embodiments, an apparatus of the present invention or methods practiced therewith may include an ion source that comprises a laser desorption/ionization ion source, a chemical ionization ion source, an electron impact ionization ion source, a photoionization ion source or an electrospray ionization ion source. These and other suitable ion sources known in the art, such as other known methods of generating ions from an analyte sample, may be used with or included in the present invention.

In certain embodiments, an apparatus of the present invention or methods practiced therewith may include an ion source that comprises at least one electrode capable of affecting the potential experienced by ions in the ion source. In certain embodiments, at least one of the ion source operating parameters includes the direct current potential of at least one of the ion source electrodes. In certain embodiments, at least one of the ion source operating parameters includes an alternating current potential of at least one of the ion source electrodes.

In certain embodiments of the present invention, the step of coordinating comprises setting values of the ion transmission device operating parameters and setting values of the ion source operating parameters, wherein at least one of the values of the ion source operating parameters is calculated based on at least one of the values of the ion transmission guide operating parameters.

In certain embodiments, an apparatus of the present invention or methods practiced therewith may include an ion transmission device that comprises a multipole radio-frequency ion guide, and at least one of the ion transmission guide operating parameters includes the amplitude and frequency of the radio-frequency alternating current potential of the multipole ion guide electrodes.

In certain embodiments of the present invention, the step of coordinating comprises monitoring in real-time at least one of the operating parameters of the ion transmission device. In certain embodiments of the present invention, the potential applied to the at least one of the electrodes of the ion transmission device is monitored in real-time.

In certain embodiments of the present invention in which the ion source and the ion transmission device are in signal communication with a controller, the step of coordinating comprises configuring the controller to set at least one of the values of the ion source operating parameters, wherein said at least one set values are predetermined based on at least one of the values of the ion transmission device operating parameters as determined by the controller. In certain embodiments in which the ion source operating parameters are predetermined for a given mass range, the ion current is improved for the given mass range. In certain embodiments, the given mass range is user-defined.

In certain embodiments of the present invention in which the ion source and the ion transmission device are in signal communication with a controller, the step of coordinating comprises configuring the controller to set at least one of the values of the ion source operating parameters, wherein said at least one set values are predetermined based on a given mass range. In certain embodiments of the present invention, the given mass range is user-defined.

In certain embodiments of the present invention in which the ion source and the ion transmission device are in signal communication with a controller, the step of coordinating comprises configuring the controller to set at least one of the values of the ion source operating parameters, wherein the at least one of said set values are calculated based on at least one of the values of the ion transmission device operating parameters.

In certain embodiments of the present invention in which the ion source and the ion transmission device are in signal communication with a controller, the step of coordinating comprises configuring the controller to set at least one of the values of the ion source operating parameters, wherein said at least one set values are predetermined for a given mass range of ions, and whereby the controller is capable of coordinating the respective values of the operating parameters of the ion source and the ion transmission device for the given mass range.

In certain embodiments of the present invention in which the ion source and the ion transmission device are in signal communication with a controller, the step of coordinating comprises configuring the controller to set at least one of the values of the ion source operating parameters, wherein at least one of said set values are calculated based on at least one of the values of the ion transmission device operating parameters, and whereby the controller is capable of coordinating the respective values of the operating parameters of the ion source and the ion transmission device.

In certain embodiments of the present invention in which the ion source and the ion transmission device are in signal communication with a controller, the step of coordinating comprises configuring the controller to set at least one of the values of the ion source operating parameters, wherein said at least one set values are based on the values of the ion transmission device operating parameters, and whereby the controller is capable of coordinating the respective values of the operating parameters of the ion source and the ion transmission device.

In another aspect, the present invention provides an apparatus for controlling the ion current of an ion transmission device therein.

An apparatus of the present invention comprises an ion source, an ion transmission device in ion communication therewith, and a controller configured to coordinate respective values of the operating parameters of the ion source and the ion transmission device. In certain embodiments, the controller comprises a digital computer and/or memory. In certain embodiments, the controller is in signal communication with the ion source and the ion transmission device of the apparatus. In certain embodiments, the controller is configured to coordinate the value of at least one ion source operating parameter with the value of at least one ion transmission device operating parameter.

In certain embodiments of the apparatus, the controller, when coordinating the respective values of the operating parameters, is configured to determine at least one of the values of the ion transmission device operating parameters and set at least one of the values of the ion source operating parameters, wherein the values set for the ion source operating parameters are selected from a set of predetermined values based on the values determined for the ion transmission device operating parameters. In some embodiments, the controller comprises memory in which the set of predetermined values are stored.

In certain embodiments of the apparatus, the controller, when setting the values of the ion source operating parameters, is configured to calculate at least one of the values of the ion source operating parameters, wherein said calculation is based on at least one of the values of the ion transmission device operating parameters.

In certain embodiments of the apparatus, the controller, when coordinating the respective values of the operating parameters, is configured to set at least one of the values of the ion transmission device operating parameters and set at least one of the values of the ion source operating parameters, wherein said set values of the ion source operating parameters are predetermined for providing ions of a given mass range from the ion source to the ion transmission device. In certain embodiment, the given mass range is user-defined.

In certain embodiments of the apparatus, the ion source may be a laser desorption/ionization ion source, a chemical ionization ion source, an electron impact ionization ion source, a photoionization ion source, an electrospray ionization ion source, or a plasma desorption ion source.

In certain embodiments of the apparatus, the ion source comprises at least one electrode capable of affecting the potential experienced by ions in the ion source. The ion source operating parameters may include the magnitude of a direct current potential of at least one of the ion source electrodes. The ion source operating parameters may also include the frequency and amplitude of an alternating current potential of at least one of the ion source electrodes.

In certain embodiments of the apparatus, the ion transmission device comprises a multipole radio-frequency ion guide. The ion transmission device operating parameters may include the amplitude of a radio-frequency alternating current potential of the multipole radio-frequency ion guide electrodes. The multipole radio-frequency ion guide may include a quadrupole ion guide, a hexapole ion guide, or an octopole ion guide.

In certain embodiments of the apparatus, the ion source comprises systems and components for providing a gas flow field, such as are known in the art.

In certain embodiments, the apparatus may further comprise one or more mass analyzers. Suitable mass analyzers may include a quadrupole mass filter, a reflectron, a time-of-flight mass analyzer, an electric sector time-of-flight mass analyzer, a triple quadrupole apparatus, a Fourier transform ion cyclotron resonance mass analyzer, a magnetic sector mass analyzer, or other suitable mass analyzers known in the art. It is understood that the present invention embraces embodiments in which the apparatus does not include a mass analyzer component with the ion source and ion transmission device. In some embodiments, the apparatus may be a tandem mass spectrometer.

In certain embodiments of the apparatus, one or mass analyzers are in ion communication with the ion transmission device. The mass analyzer may disposed at either the entry or the exit of said ion transmission device. In some embodiments, one or more optional intervening components may be disposed between the ion transmission device and the mass analyzer, wherein the optional intervening component may allow and/or facilitate ion communication between the mass analyzer and the ion transmission device.

In certain embodiments of the apparatus, the ion transmission device may include a mass analyzer. For example, in some embodiments the apparatus of the present invention may comprise an ion source in ion communication with an ion transmission device, wherein the ion transmission device is a mass analyzer. In other embodiments, the ion transmission device may include one or more mass analyzers and one or more ion guides, such as a multipole ion guide. In these embodiments, the mass analyzer and the ion guide function together as an ion transmission device.

In certain embodiments, the apparatus may further comprise an ion current measuring device or an ion mobility spectrometer. The apparatus may also further comprise an ion detector.

In still another aspect, the present invention provides an apparatus that includes an ion source in ion communication with an ion transmission device, and a system for coordinating the respective operating parameters of the ion source and the ion transmission device. In certain embodiments of the apparatus, the coordinating system comprises a component for determining at least one of the values of the ion transmission device operating parameters.

In certain embodiments of the apparatus, the coordinating system comprises a component for setting at least one of the values of the ion source operating parameters, wherein at least one of the values set for the ion source operating parameters is based on at least one of the values determined for the ion transmission device operating parameters.

In certain embodiments, the apparatus may further comprise a system for the mass analysis of ions, wherein the coordination system improves the sensitivity of said system for ion mass analysis.

### BRIEF DESCRIPTION OF THE DRAWINGS

the above and other objects and advantages of the present invention will be apparent upon consideration of the following detailed description taken in conjunction with the accompanying drawings, in which like characters refer to like parts throughout, and in which:

FIG. 1 is a block diagram of an embodiment of the present invention;

FIG. 2 is a schematic view of an exemplary ion source of an embodiment of the present invention;

FIG. 3 is a schematic isometric view of an exemplary ion transmission device of an embodiment of the present invention;

FIGS. 4A-4J are representative graphs that depict, in principle, the prophetic relationship between the applied AC potential and the mass distribution of the ion current in an ion transmission device of an embodiment of the present invention, and further depict an exemplary coordination of an ion source and an ion transmission device in an embodiment of the present invention;

FIGS. 5A-5C are exemplary ion trajectory simulations in an ion source in an embodiment of the present invention;

FIG. 6 is a schematic view of an exemplary apparatus of an embodiment of the present invention; and

FIG. 7 is a perspective view of an axial cut-away of an embodiment of the present invention, showing an exemplary ion source in operable alignment with an exemplary multipole device, and further showing exemplary simulated ion trajectories.

### DETAILED DESCRIPTION OF THE PREFERRED EMBODIMENTS

In apparatus and methods of the present invention, an ion source is in ion communication with an ion transmission device. Applying a set of operating parameters to the ion source can determine the characteristics of the ions generated by the ion source. Similarly, applying a set of operating parameters to the ion transmission device can determine the characteristics of the ions transmitted through the ion transmission device. Applying a set of operating parameters to the foregoing components refers to setting or providing values for one or more of their operating parameters.

In a first aspect, the present invention provides methods for controlling the ion current of an ion transmission device in ion communication with an ion source.

The method comprises coordinating the operating parameters of an ion transmission device with the operating parameters of an ion source. In some embodiments, the method involves coordinating values of the operating parameters of the respective components.

Examples of operating parameters of the ion transmission guide source include, without limitation, any characteristics of the potentials applied to one or more of the electrodes of the ion transmission guide, such as the electrodes of a multipole radio-frequency ion guide. Such characteristics include, without limitation and where relevant, the characteristics of applied DC potentials, AC potentials, or any other arbitrarily time-dependent waveform. These include the magnitude of the applied potentials, wherein the magnitude may be determined by absolute value, peak, root-mean-square, average, or the like. These characteristics also include the frequencies and amplitudes of applied waveforms, the magnitudes of phase shifts between two or more applied waveforms, the shapes of applied waveforms, pertinent time intervals between changes in state and other values, and other like characteristics.

Examples of operating parameters of the ion source that can be coordinated with operating parameters of the ion transmission guide include, without limitation, any characteristics of the potentials applied to one or more of the electrodes of the ion source. Such characteristics include, without limitation and where relevant, the characteristics of applied DC potentials, AC potentials, or any other arbitrarily time-dependent waveform. These include the magnitude of the applied potentials, wherein the magnitude may be determined by absolute value, peak, root-mean-square, average, or the like. These characteristics also include the frequencies and amplitudes of applied waveforms, the magnitudes of phase shifts between two or more applied waveforms, the shapes of applied waveforms, pertinent time intervals between changes in state and other values, and other like characteristics.

In some embodiments of the present invention, the operating parameters of the ion source and the ion transmission device may be coordinated such that the characteristics of the ions generated by the ion source are substantially commensurate with the characteristics of the ions transmitted through the ion transmission device. Proper coordination results in improvement of the ion current of the ion transmission device. Coordination of these respective operating parameters may also result in improvements in the measurement and detection of the ions.

In some preferred embodiments, a controller may be configured to coordinate the operating parameters of the ion source and the ion transmission device of the present invention. A controller can thereby coordinate the respective operating parameters of the ion source and the ion transmission device in a manner directed towards control of the ion current of the ion transmission device.

In some embodiments of the present invention, coordination of the respective operating parameters of the ion source and the ion transmission device requires applying or changing values of one or more of the operating parameters. In some embodiments, these changes or applications of operating parameter values to a first component, such as an ion source, are effected with regard to changes or applications of values to the operating parameters to a second component, such as an ion transmission device. Such values may include characteristics of the electrostatic or electromagnetic properties of electrodes in the components of interest. Such characteristics may include, for example, the properties of the applied AC or DC potentials, the properties of the applied AC or DC currents, the frequencies and amplitudes of applied waveforms, the magnitudes of phase shifts between two or more waveforms, the shapes of applied waveforms, pertinent time intervals between changes in state and other values, and other like characteristics known to affect the operation of ion sources and ion transmission devices of the present invention.

In some embodiments of the present invention, the operating parameters may include either or both of digital and analog values. The operating parameters may include settings for the ion source or ion transmission device that represent or reflect its electric and electronic characteristics, its spatial and physical characteristics, its temporal characteristics, and other characteristics that are known in the art relating to such components.

In some embodiments of the present invention, coordination of the values of these respective operating parameters may involve measuring, calculating, querying, recalling, or other suitable method for determining the values of one or more of the operating parameters on a first component (e.g., ion source, ion transmission device, etc.). Such determination may be made transiently or in real-time. For example, the controller may measure directly values of one or more operating parameters of a component (e.g., applied AC or DC potentials, the AC peak amplitude and frequency, etc.). The controller may also calculate or derive one or more operating parameter values based on other known or measured parameters. The controller may query another controller in closer proximity to the component of interest to obtain the desired values. The controller may also recall the values of the operating parameters that were applied previously to the component, instead of determining anew the values from the component itself. It is also understood that suitable combinations of the foregoing determination methods may also be used.

Concurrent with or following this determination of the operating parameters, suitable operating parameter values are applied to the second component based on one or more of the parameters determined from the first component. For example, one or more values of the operating parameters of the ion transmission device (such as the amplitude of the applied AC potential) may be measured or otherwise determined by a controller in the apparatus. Based on this determination, one or more suitable values are applied to the operating parameters of the ion source by the controller, thereby coordinating both sets of operating parameters with respect to each other.

The foregoing coordination method of the present invention may also be performed unidirectionally, reciprocally, or any other suitable combination thereof. For example, one or more operating parameters may be determined on both components, and based on this determination, the controller may apply suitable operating parameters on the other components.

Further to the above, in some embodiments of the present invention, coordination of the respective operating parameters may require monitoring the component for changes to its operating parameter values. Such monitoring may be performed in real-time, at periodic intervals, or at other suitable times or intervals. In these embodiments, changes to one or more of the operating parameter values of a first component may result in a coordinate changes of one or more of operating parameter values of the other component. For example, the controller may monitor one or more of the operating parameter values of the ion transmission device. If the controller determines that the values of one or more of these parameters (e.g., the AC potential applied to the ion transmission device) has changed, the controller may apply a coordinate change in the values of the operating parameters of the other component (e.g., the ion source).

In some embodiments of the present invention, coordination of the respective operating parameters may require applying suitable operating parameter values to both the ion source and the ion transmission device in a coordinate yet independent manner. Such coordination may not require determination of the operating parameter values of one or both components, but instead the respective operating parameter values are matched prior to their application, and applied to both respective components coordinately. For example, the controller may include a lookup table or other suitable database in which each given set of ion source operating parameters is matched with a corresponding set of ion transmission device parameters. Such operating parameter values may have been predetermined, newly calculated from other values, or other suitable combinations thereof.

In some embodiments of the present invention, one or more values of the operating parameters that are applied to the ion source and ion transmission device may be calculated or derived by other suitable mathematical or logical systems. These calculated operating parameter values may be thus derived from one or more other operating parameter values. For example, to coordinate the respective operating parameters of the ion source and the ion transmission device of the present invention, one or more values of the operating parameters (e.g., the peak amplitude of the applied AC potential) may be determined by querying or measuring the ion transmission device. The controller may then calculate or otherwise derive one or more of values of the ion source operating parameters based on one or more of the values of the ion transmission device operating parameters.

In some embodiments of the present invention, one or more values of the operating parameters applied to the ion source and the ion transmission device may be predetermined. In such embodiments, such predetermined operating parameters may not require real-time calculations or logical transformations by the controller. Predetermined operating parameter values may be generated by calculating the operating parameters in advance, and then pre-loading or storing the values in the controller for subsequent retrieval and application to the component. Other suitable methods for predetermining operating parameter values may include empirical observation of and experimentation with the component in question. Predetermined operating parameter values may be determined based on computer simulations of the components under simulated operating conditions.

It is also within the scope of the present invention that the operating parameter values may be determined by ascertaining a mathematical or other algorithmic relationship between the desired operating parameters and other known operating parameters. It is also within the scope of the present invention that, with respect to any of the foregoing methods, such determination may make determination of operating parameters more efficient by reducing the degrees of freedom among the known operating parameters. Predetermined operating parameters calculated by these methods may then be stored in memory storage of the controller such that the calculated does not need to be performed again.

In some embodiments of the present invention, coordination of the respective operating parameter values may be performed over several intervals. For example, a first set of operating parameter values may be applied to a first component (e.g., the ion transmission device) and a corresponding first set of operating parameter values may be applied to a second component (e.g., the ion source). These first sets may be maintained on each component for a period of time. The length of a period may be fixed or predetermined, or may be conditioned on other events. Following this period, a second set of operating parameter values may then be applied to the first component and a corresponding second set of operating parameters may be applied to the second component. This continued coordination of the respective operating parameters may continue to be maintained for many intervals or periods of time.

In some embodiments, coordination of the respective operating parameters of the first and the second components involves synchronizing the respective operating parameter values. In some other embodiments, such coordination may be offset by a suitable time period or other criteria. For example, a given set of operating parameter values may be applied to a first component, and a corresponding set of operating parameter values may be applied to a second component following a period of time after the first application. In some embodiments, this temporal order may be reversed. The temporal offset may be predetermined, or may be responsive to the certain parameters. For example, a set of operating parameters may be applied to an ion source to allow ions of a certain mass range to be extracted. After a period of time to allow these ions to travel to the entrance of the ion transmission device, the corresponding set of operating parameter values may then be applied to the ion transmission device, thereby effecting coordination of the respective operating parameter values in accordance with the present invention.

In a preferred embodiment, an apparatus includes an ion source with a plurality of electrodes in ion communication with an ion transmission device, which is an multipole radio-frequency ion guide (RFIG). In this embodiment, coordination of the operating parameter values of an ion source with operating parameter values of the multipole RFIG includes setting one or more values for the AC potentials applied to the multipole RFIG electrodes. Based on these values applied to the RFIG, the potentials applied to one or more of the ion source electrodes are set. In certain conditions, this coordination of the operating parameter values of the ion source with the operating parameter values of the multipole RFIG results in an improved or increased ion current from the RFIG, compared.

Coordination of the respective values also includes the situation in which one or more of the operating parameter values are changed on the multipole RFIG. For example, the RFIG may be ramped, thereby changing the peak amplitude of the AC potential applied to its electrodes. In response to this change of values in the RFIG, one ore more of the operating parameter values of the ion source are also changed. For example, the potentials applied to one or more of the ion source electrodes are also changed in response to the change in values of the RFIG. Therefore, coordination of the respective operating parameter values in this manner in accordance with the present invention may result in changing the respective values in a substantially synchronous manner.

In accordance with methods and apparatus of the present invention, control of the ion current of the ion transmission device may result in useful improvements to the ion current in the ion transmission device compared to prior practices. For example, previously when a predetermined set of operating parameters had been applied to the ion source, these operating parameters were generally not changed during the operation of the apparatus, nor were they changed or coordinated with the operating parameters of other components, such as that of the ion transmission device. Accordingly, improvements of the present invention resulting from coordination of the respective operating parameters may be at least one-and-one-half-fold, at least two-fold, at least three-fold, or at least-five fold over an apparatus or methods in which the ion source operating parameters have not been coordinated with the ion transmission device operating parameters.

Similarly, in some embodiments such improvements in the ion current may also result in commensurate or proportional improvements in the ion derived signal measured by the apparatus. For example, in an apparatus of the present invention that includes a TOF mass analyzer, improvements in the ion current resulting from the methods and apparatus described herein may also increase the signals and amount of detected ions by the TOF apparatus.

Coordinating respective operating parameters in accordance with the present invention may be used to control other aspects of the ion current, other than improvement of the ion flux. For example, control of the ion current may be used to increase ion flux with respect to one or more selected ion species, to decrease ion flux with respect to one or more selected species, to enrich one or more ion species, to diminish one or more ion species, to control the distribution of velocities (with respect to either or both of the magnitude or directions) of the ion current, and any other suitable properties of the ion current or suitable combinations thereof.

Coordination of the operating parameters of an ion source and an ion transmission device, in accordance with the present invention, has several advantages and differences over previous methods and apparatus. First, in contrast to previous methods, coordinating the respective operating parameters may provide values for the operating parameters that are suitable for controlling the ion current of the ion transmission device. Previously, controlling the ion current of the ion transmission device was not considered when setting the operating parameters of other components, in particular the operating parameters of the ion source.

Second, in contrast to previous methods, coordination of the operating parameters in accordance with the present invention may require setting or providing values for the operating parameters for one component (e.g., the ion source) based on the operating parameters of another component (e.g., the ion transmission device). For example, one or more values of the operating parameters of an ion transmission device may be determined. Based on this determination, a corresponding set of operating parameters may then be applied to the ion source. Previously, operating parameters for one component were usually set to affect functionality of that component, and not necessarily the functionalities of other components.

Third, in contrast to previous apparatus, the present invention includes a controller component suitable for and configured to coordinate the respective operating parameters of the ion source and the ion transmission device. Previous apparatus lacked such a controller, and particularly one configured for coordinating the respective operating parameters of the two components. More particularly, previous apparatus lacked a controller configured to effect such coordination in order to effect control of the ion current in the ion transmission device.

Fourth, in contrast to previous methods and apparatus, operating parameters for one or more components of an apparatus of the present invention may be predetermined and subsequently stored. Accordingly, during coordination of the respective operating parameters, the stored, predetermined operating parameters may be applied to their respective components. Storing and using predetermined operating parameters in the present invention may be particularly useful when mutually coordinated sets of operating parameters may be too complex or time-consuming to calculate in real-time.

In another aspect, the present invention provides an apparatus for controlling the ion current of an ion transmission device. Such apparatus of the present invention effects this ion current control by coordinating the operating parameters applied to the ion source with that of the ion transmission guide, both of the present invention.

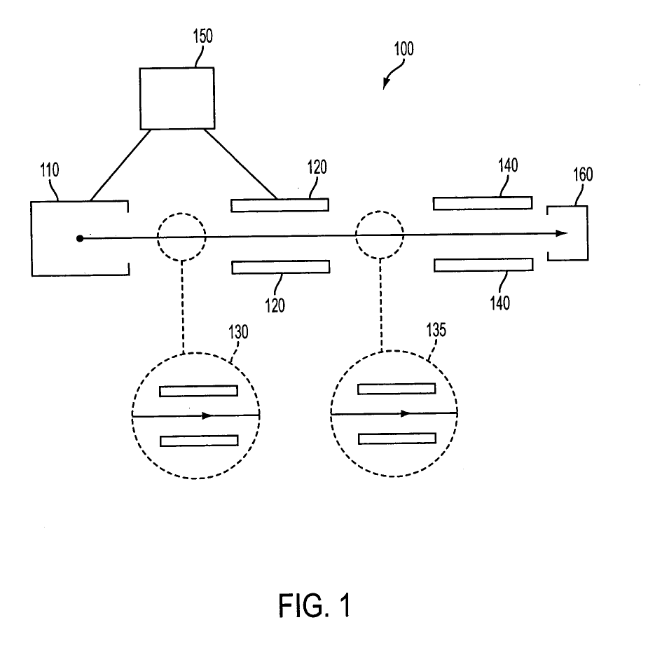

Referring to FIG. 1, a block diagram of an embodiment of an apparatus of the present invention is depicted. Apparatus 100 comprises ion source 110 and ion transmission device 120. Ion source 110 is in ion communication with ion transmission device 120, such that ions may travel from the ion source to the ion communication device.

Apparatus 100 of the present invention may also include optional intervening component 130 disposed between ion source 110 and ion transmission device 120. If present, intervening component 130 is in ion communication with both ion source 110 and ion transmission device 120, thus allowing ions from ion source 110 to enter ion transmission device 120 via intervening component 130. Likewise, optional intervening component 135, if present, may be disposed following ion transmission device 120 in a manner similar to intervening component 130, such that ions may travel from ion transmission device 120 and distal component 140 via intervening component 135.

If either or both are present, intervening components 130 and 135 may include, for example, deflecting electrodes (having static or dynamic applied potentials), electrostatic lenses, apertures, mass filters, ion transmission devices, cooling cells, collision cells, ion fragmentation cells, mass analyzers, multipole devices, ion guides, and other like devices or suitable combinations thereof. Intervening components 130 and 135 may serve to limit or restrict the entry to or exit from components of apparatus 100 to which they are proximately situated. Intervening components 130 and 135 may also serve to affect the potentials or electromagnetic environment of ions. Intervening components 130 and 135 may also effect other changes to the ions, such as mass- or charge-dependent filtration or selection of ions, fragmentation, redirection or deflection, reduction in kinetic energy (i.e., cooling), linear or angular acceleration, and other suitable or necessary functions as are known in the art.

Apparatus 100 of the present invention also includes distal component 140 that is capable of receiving ions from ion transmission device 120, or via intervening component 135, if present. Distal component 140 may include one or more mass analyzers, one or more mass spectrometers, a total ion current measuring device, an ion mobility spectrometer, and other like devices known in the art, as well as suitable combinations thereof. In the present invention, the ion current of the ion transmission device may affect the quantity and distribution of ions that are received by the distal component.

The present invention also embraces embodiments of apparatus 100 in which distal component 140 is optional. In such embodiments, apparatus 100 of the present invention minimally comprises ion source 110, ion transmission device 120, and controller 150. Such an apparatus may serve as a particularly useful and improved means for generating ions with an improved ion current.

Apparatus 100 of the present invention also includes ion detector 160, which may include an ion detector for detecting ions, and may also include a component for amplifying ion signals, examples of which are known in the art, and thus will not be discussed in detail here. For example, ion detector 160 may include continuous electron multipliers, discrete dynode electron multipliers, scintillation counters, Faraday cups, photomultiplier tubes, and the like. Ion detector 160 may also include a system or component for recording ions detected therein, such as a computer or other electronic apparatus.

In some embodiments of the present invention, apparatus 100 may be a single-stage mass spectrometer apparatus. In such embodiments, mass analysis is performed by a mass analyzer included within distal component 140. Suitable mass analyzers include, for example, a quadrupole mass filter, a reflectron, a time-of-flight mass analyzer, an electric sector time-of-flight mass analyzer, a triple quadrupole apparatus, a Fourier transform ion cyclotron resonance mass analyzer, a magnetic sector mass analyzer, or other suitable mass analyzers known in the art.

In some embodiments of the present invention, apparatus 100 may be a tandem mass spectrometer, whereby apparatus 100 comprises two or more mass analyzers. In some tandem mass spectrometer embodiments of the present invention, distal component 140 of apparatus 100 may include the one or more mass analyzers. For example, distal component 140 can be selected from the group consisting of a quadrupole-TOF MS, an ion trap MS, an ion trap TOF MS, a TOF-TOF MS, a Fourier transform ion cyclotron resonance MS, with an orthogonal acceleration quadrupole-TOF MS a particularly useful embodiment.

In other embodiments, both ion transmission device 120 and distal component 140 may each include one or more mass analyzers. For example, ion transmission device 120 may include a first mass analyzer and distal component 140 may include a second mass analyzer. In some of such embodiments, the first mass analyzer is ion transmission device 120. In other of such embodiments, ion transmission device 120 may include one or more mass analyzers and one or more ion guides, whereby the mass analyzers and ion guides function together as ion transmission device 120. Control of ion transmission device 120 by controller 150 may be effected by control of one or more of said mass analyzers and ion guides.

In one example of an apparatus of the present invention having multiple mass analyzer components, apparatus 100 comprises a suitable ion source as ion source 110, one or more multipole (e.g., quadrupole) ion guides and/or mass filters as ion transmission device 120, and a time-of-flight mass analyzer as distal component 140. In another example, apparatus 100 comprises a suitable ion source as ion source 110, one or more multipole (e.g., quadrupole) ion guides and/or mass filters as ion transmission device 120, and a Fourier transform ion cyclotron resonance mass analyzer as distal component 140.

Apparatus 100 of the present invention also includes controller 150 which is configured to coordinate the operating parameters of ion source 110 and ion transmission device 120. Controller 150 may be in signal communication with ion source 110 and ion transmission device 120. Such signal communication may occur by either or both analog or digital signals. In some embodiments, controller 150 may include one or more digital computers, including a processor and memory storage. Controller 150 may also be configured to store values of operating parameters, such as predetermined operation parameters or those determined from one or more of the components of the apparatus.

In some embodiments of the present invention, controller 150 may be configured to provide one or more values for the operating parameters of ion source 110. Similarly, controller 150 may also be configured to provide one or more values for the operating parameters of ion transmission device 120. In addition, in some embodiments of the present invention controller 150 may also be configured to determine one or more of the operating parameters of either or both of ion source 110 and ion transmission device 120. Such determination may be made by, for example, measuring or otherwise deriving the parameter to be determined from the device or its immediate controller, querying the device or its immediate controller for the desired parameter, determining the desired parameters based on the parameters that were recently provided to the device, and other suitable methods or combinations thereof as are known in the art.

Ion source 110 includes any systems or methods for generating ions that are known in the art. Ions may be generated in ion source 110 in a continuous or pulsed manner. Ion source 110 may include means for producing a plurality of ions within a relatively small volume and within a relatively short time. Also included are any of the systems or methods known in the art for producing a pulse of ions, such that the pulse of ions has the appearance of or behaves as if the ions were produced within a relatively small volume and within a relatively short time. Ion source 110 may also include systems or methods for producing a continuous beam of ions, or by any of the known systems or methods of producing an essentially continuous or extended beam of ions from an initially generated pulse of ions. Ion source 110 may also include systems or methods to concentrate the ions, such as a quadrupole ion trap, a linear ion trap, and other suitable systems or combinations thereof.

Ion source 110 may, for example, include systems or methods that employ a pulsed laser interacting with a solid surface, a pulsed focused laser ionizing a gas within a small volume, or a pulsed electron or ion beam interacting with a gas or solid surface. In another example, ion source 110 may employ systems or methods for generating a pulse of ions that uses a rapidly sweeping, continuous ion beam passed over a narrow slit, in which a brief pulse of ions is produced by the ions passing through the slit when the ion beam passes thereover.

Ion source 110 may employ, but is not limited to use of, electrospray ionization, laser desorption/ionization (“LDI”), matrix-assisted laser desorption/ionization (“MALDI”), surface-enhanced laser desorption/ionization (“SELDI”), surface-enhance neat desorption (“SEND”), affinity capture laser desorption/ionization, fast atom bombardment, surface-enhanced photolabile attachment and release, pulsed ion extraction, plasma desorption, multi-photon ionization, electron impact ionization, inductively coupled plasma, chemical ionization, atmospheric pressure chemical ionization, hyperthermal source ionization, and the like.

Furthermore, ion source 110 may also include systems or methods for selectively providing ions of one or more masses or ranges of masses, or fragments therefrom. Such systems or methods may be accomplished by combining the apparatus of the present invention in tandem fashion with a mass analyzer that is known in the art, wherein the mass analyzer may include components such as magnetic sectors, electric sectors, ion traps, multipole devices, mass filters, TOF devices, and the like. The combined mass analyzer and ion source may be included as part of ion source 110.

Ion source 110 may also include systems or methods for extracting or accelerating ions from the ion source, such as by application of an electric field or voltage pulse. Such systems or methods may be parallel (i.e., coaxial) or orthogonal with respect to the trajectory of the initially-generated ions, such as an ion beam. Extraction or acceleration of the ions may occur subsequent to the formation of the ions. Ion source 110 may also include systems or methods for reducing the initial kinetic energies of the ions that may result from their desorption or ionization, such as by collisional cooling means. Accordingly, ion source 110 may also include a gas flow field, as is known in the art.

Ion source 110 may, in certain embodiments, use superposed electrostatic and gas flow fields, as further described and claimed in the commonly owned patent application filed concurrently herewith by Andreas Hieke, entitled “Ion Source With Controlled Superposition Of Electrostatic And Gas Flow Fields” (attorney docket number CiphBio-16), the disclosure of which is incorporated herein by reference in its entirety. The advantages of the present invention become particularly apparent when such ion sources are used. In these embodiments, ion motion is determined by a multitude of factors, including the initial conditions, the ion mass, the collision cross-section, the spatial distribution of the gas flow velocity vector field, the spatial distribution of the gas flow pressure field, and other like conditions. Accordingly, methods and apparatus of the present invention may allow control and improvement of the total ion current over a wide mass range in these embodiments.

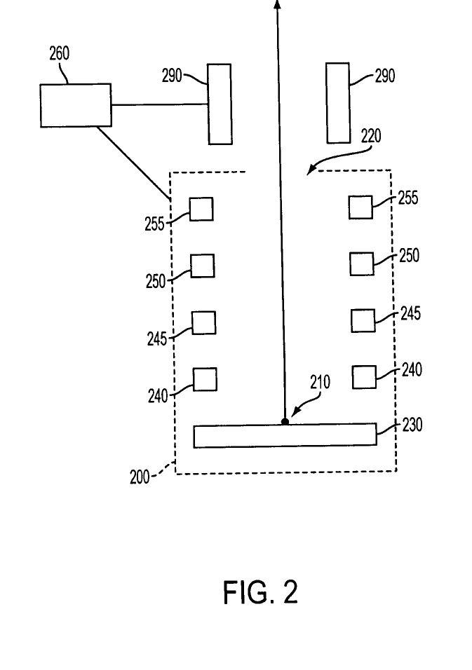

Referring to FIG. 2, an exemplary ion source embodiment of the present invention is depicted. Ion source 200 is depicted schematically in cross-sectional view, in which the vertical axis corresponds approximately to the longitudinal ion extraction path. It is understood that the particular number, arrangement, shapes, configuration and other features of the ion source and its electrodes as depicted in ion source 200 and described herein are an exemplary embodiment of the present invention provided for illustrative purposes. Other conceivable ion source configurations, including those known in the art, are envisioned to be included within the scope of the present invention.

Like ion source 100 in FIG. 1, ion source 200 may be in ion communication with ion transmission device 290 via ion source exit 220, either directly or via optional intervening components, such as those described herein. Accordingly, ions that exit via ions source exit 220 may be received by and thereby may enter ion transmission device 290.

In ion source 200, ions are generated at or near ion generation point 210, such as by laser desorption/ionization or other suitable ion generation systems or methods, including those listed herein. Ions generated at point 210 may have initial thermal energies resulting from the desorption, ionization, or other step during or following generation of the ions from the sample.

In the:exemplary embodiment of the present invention depicted in FIG. 2, ion source 200 includes basal electrode 230 and electrodes 240-255. Electrodes 230-255 preferably have an axisymmetric configuration, but may also comprise discrete electrode elements. Operating parameters of these electrodes may include, for example, direct current (DC) potentials, alternating current (AC) potentials, or any other arbitrarily time-dependent waveform or suitable combinations thereof may be applied independently to each of these electrodes such that each electrode may have different potential values. Another operating parameter is the waveform of the applied potentials. The applied potentials may also have an arbitrary waveform, such as sinusoidal, square, sawtooth, and other suitable forms. As a result of these applied potentials, each electrode may affect the potential experienced by ions within ion source 200. In preferred embodiments of the present invention, the electric field resulting from electrodes 230-255 is configured to accelerate and direct ions towards ion source exit 220.

In this embodiment, other operating parameters of ion source 200 may include, for example, the magnitude and timing of potentials applied to one or more of electrodes 230-255. Still other operating parameters may include the physical locations of one or more of the electrodes within the ion source, parameters relating to any time-dependent application of potentials to one or more of the electrodes, parameters relating to the generation of the ions or introduction of the sample, and other suitable operating parameters of ion sources that are known in the art.

Control of one or more the foregoing ion source operating parameters may be effected by, for example, controller 260 in signal communication with ion source 200. Controller 260 may thereby apply or set one or more of the operating parameters of ion source 200. Controller 260, or another suitable device, may also be configured to determine one or more of the current operating parameters of ion source 200 (as described above), such as by measuring, querying, or deriving said parameters from ion source 200.

An apparatus of the present invention also includes an ion transmission device, such as ion transmission device 120 and 290 represented in FIGS. 1 and 2, respectively. An ion transmission device of the present invention serves to conduct one or more ions from its entrance to its exit. The entrance of an ion transmission device of the present invention may be in ion communication with an ion source, such as ion source 110. The exit of an ion transmission device of the present invention may be in ion communication with a distal component or mass analyzer, such as distal component 140. Referring to FIG. 1 as an example, ions that exit ion source 110 of the present invention may then enter ion transmission device 120 (either directly or via an optional intervening component). Ion transmission device 120 may then conduct the ions to subsequent distal component 140 (either directly or via an optional intervening component). In some embodiments of the present invention, the distal component includes one or more mass analyzers and ion detectors. As described hereinabove, it is understood that the present invention embraces embodiments in which distal component 140 is optional, such that apparatus 100 minimally comprises ion source 110, ion transmission device 120, and controller 150.

One operational metric of the ion transmission device is its ion current. Ion current may generally refer to the flux of ions (or other charged species) at a given point or through a given cross-section in an ion path. Ion current can reflect the total flux of all ions, irrespective of ion mass. Under certain circumstances, it may be more useful to determine partial ion current as a function of ion mass. Partial ion currents may be particularly useful to identify and to measure mass-dependent selectivity and preferences within the apparatus.

For example, an ion transmission device in the apparatus according to the present invention may exhibit a mass-dependent selectivity when conducting ions therethrough. To demonstrate such selectivity, a partial ion current can be measured for each mass or range of masses as ions enter and exit the device. Ion masses to which the ion transmission device exhibits either positive or negative selectively may result in a higher or lower corresponding partial ion current at the exit of the device.

The ion current of an ion transmission device in the apparatus according to the present invention reflects the ion flux at the exit of the ion transmission device. Using apparatus 100 in FIG. 1 as an example of the present invention, the ion current of ion transmission device 120 therefore reflects the flux, or amount, of ions exiting ion transmission device 120. Accordingly, this ion current may also reflect the ion flux, or amount of ions, that is entering distal component 140 (either directly or via optional intervening component 135).

The ion current of the ion transmission device may be particularly relevant with respect to components that are distal from the ion transmission device, and thus are capable of receiving ions therefrom. In preferred embodiments, these components may include a mass analyzer and ion detector. Accordingly, the ion current can be an important indicator of the operating performance of the apparatus.

For example, in some embodiments of the present invention, distal apparatus 140 of FIG. 1 may include a time-of-flight (TOF) mass analyzer. A TOF mass analyzer is capable of receiving and measuring individual ions over a broad range of masses, in which the signal strength for each ion may correspond to the amount of that ion received by the analyzer. In such cases, high ion currents are preferable to low ion currents, as the former may result in a stronger signal by the mass analyzer. Therefore, it is desirable in these and other contexts to improve the ion current over all ion masses.

Ion transmission device 120 of FIG. 1 may include any suitable device for conducting or transmitting ions that are known in the art. Examples of ion transmission devices may include ion guides, multipole devices (such as quadrupoles, hexapoles, octopoles, etc.), electrostatic ion guides, electromagnetic ion guides, and other like devices or combinations thereof. Ion transmission device 120 may include a plurality of such devices arranged in serial ion communication. For example, ion transmission device 120 may include a triple-quadrupole device, as is known in the art, in which three quadrupoles (a first mass filter, a collision cell, and a second mass filter) are arranged in series.

In some embodiments of the present invention, ion transmission device 120 may include one or more ion guides, as are known in the art. Ion guides are suitable for conducting one or more ions from its entrance to its exit. In some embodiments, ion guides of the present invention are configured to confine and focus an ensemble of mobile ions within a potential envelope. In this manner, only those ions that can maintain a stable trajectory within the ion guide are then able to exit the ion guide.

In some ion guide embodiments, conduction by the ion guides is performed by reducing or dampening the ion velocity components that are orthogonal to the longitudinal axis of the ion guide, while substantially maintaining the parallel component. In this manner, ions that exit the ion guide are more focused in a single direction. Ion guides of the present invention may include, for example, multipole ion guides, electrostatic ion guides, electromagnetic ion guides, and other suitable ion guides and combinations thereof as are known in the art.

In some preferred embodiments of the present invention, ion transmission device 120 may include one or more multipole ion guides, as are known in the art. Multipole devices are constructed from a plurality of linear electrodes. The linear electrodes are uniformly and circumferentially arranged around a central longitudinal axis. The electrodes are also arranged such that they are parallel with respect to each other and the central axis. The approximately cylindrical shape of a multipole ion guide thereby defines a longitudinal passage through which the ions are conducted. The individual electrodes in multipole ion guides of the present invention may have cylindrical, hyperbolic, or other suitable cross-sectional geometries, as are known in the art.

In some preferred embodiments of the present invention, ion transmission device 120 may include one or more multipole ion guides having four, six, or eight electrodes (known respectively as quadrupoles, hexapoles, and octopoles), as are known in the art. In some embodiments of the present invention, ion transmission device 120 may include one or more segmented multipole devices. Such segmented multipoles may allow the application of different potentials to each segment.

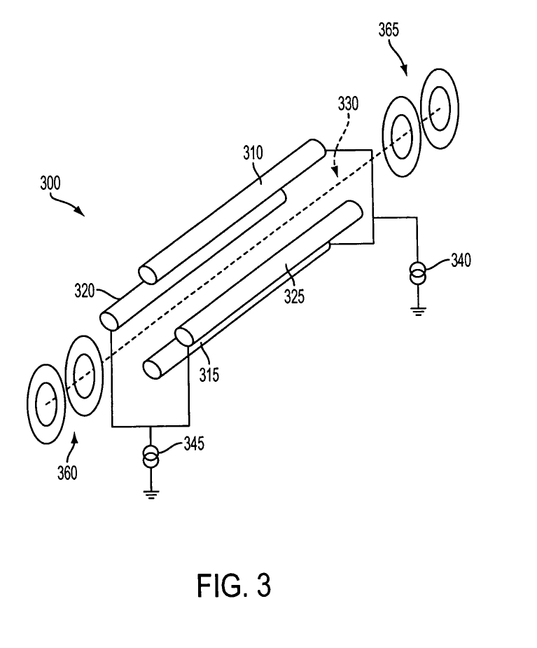

In some preferred embodiments of the present invention, ion transmission device 120 may include one or more quadrupole ion guides. Referring to FIG. 3, schematic isometric view of an exemplary quadrupole ion guide is depicted. Quadrupole 300 includes linear electrodes 310-325 arranged substantially in parallel with respect to each other. Electrodes 310-325 are also substantially parallel to and equidistant from longitudinal axis 330. Quadrupole ion guide 300 may also include one or more terminal electrostatic lenses at either or both of openings of ion guide 300, such as lenses 360 and 365. Lenses 360 and 365 may be disposed in a manner and at a location such that they may affect the potential experienced by ions entering or exiting the quadrupole.

In some embodiments of the present invention, quadrupole ion guide 300 may also include potential sources 340 and 345. Potential sources 340 and 345 are configured to apply voltage potentials to one or more of electrodes 310-325. In some preferred embodiments of the present invention, potential source 340 is configured to apply potentials to electrode pair 310 and 315, while potential source is similarly configured to apply potentials to electrode pair 320 and 325. In these embodiments, each potential source applies substantially the same potentials to both members of an electrode pair.

As is known in the art, multipoles, such as quadrupole 300, conduct mobile ions that are able to maintain stable trajectories within its electric field. The potentials applied to the electrodes from potential sources 340 and 345 may consist of a direct current (DC) potential with a superimposed alternating current (AC) potential. In quadrupole ion guide 300 of the present invention, the time-dependent potential of each electrode can be generally defined by the following equations:
Φ_{A}=+[Φ_{DC}+Φ_{AC} cos(ωt)] (Eq. 1)
Φ_{B}=−[Φ_{DC}+Φ_{AC} cos(ωt)] (Eq. 2)

In the above general equations, Φ_{A} (Eq. 1) represents the potential applied to electrodes pairs 310 and 315 by potential source 340. Similarly, Φ_{B} (Eq. 2) represents the potential applied to electrodes pairs 320 and 325 by potential source 345. Application of the potentials to each pair of electrodes in accordance with Eqs. 1 and 2 results in a phase-shift with respect to each other by approximately 180°. The waveform of the applied AC potentials is generally sinusoidal, but may also be sawtooth, square, or any other known waveform or suitable combination thereof. All of the foregoing are examples of operating parameters of an ion transmission device of the present invention

The value of Φ_{DC} represents the DC potential applied to the electrodes, while Φ_{AC} represents the peak amplitude of a superimposed AC potential. The AC potential varies periodically as a function of time (t) with a frequency ω. The frequency of the applied AC potential is typically in the radio-frequency (MHz) range. Accordingly, such ion guides are known as radio-frequency ion guides (RFIG). A suitable AC frequency is primarily determined by the ion mass or mass range to be conducted, and the geometry of the multipole device. These and other suitable or relevant variables known in the art may be included in the operating parameters of the ion transmission device of the present invention. Similarly, operating parameters may also include other appropriate values for other suitable ion transmission devices of the present invention.

Control of one or more of the foregoing operating parameters of the ion transmission device may be effected by, for example, controller 350 in signal communication with ion transmission device 300. Controller 350 may thereby apply or set one or more of the operating parameters of ion transmission device 300. Controller 350, or another suitable device, may also be configured to determine the current operating parameters or state of ion transmission device 300, such as by measuring, querying, or deriving said parameters from ion transmission device 300.

The oscillating AC potential applied to the multipole device, such as quadrupole 300, creates a dynamic electric field environment. For a given AC peak voltage, AC frequency, and quadrupole geometry, ions of a certain mass range can maintain stable trajectories and are thereby conducted to the exit of the multipole. Other species, such as those with unstable trajectories or non-charged species, will fail to be conducted to the exit and will exit the multipole at other locations.

In preferred embodiments of the present invention, quadrupole 300 of FIG. 3 functions as a multipole ion guide. In such a multipole ion guide, only the AC potential component is applied to the electrodes, whereas the DC potential component (i.e., Φ_{A} in Eqs. 1 and 2) is essentially zero. Accordingly, for multipole ion guides the generalized equations above may be reduced to the following equations:
Φ_{A}=+Φ_{AC} cos(ωt) (Eq. 3)
Φ_{B}=−Φ_{AC} cos(ωt) (Eq. 4)

Multipole ion guides still exhibit some mass selectivity, although significantly lower than that of a mass filter, and thereby conduct a broader range of ions masses. In certain embodiments and applications of the present invention, such broad permissibility of ion transmission is preferable and advantageous. For example, a multipole ion guide that provides a broad range of ion masses is preferable when the ions exiting the ion transmission device are subject to subsequent mass analysis, such as by a time-of-flight mass analyzer. Therefore, it is even more preferable under these and other circumstances to have an even broader range of ion masses transmitted by the ion guide. Accordingly, it is desirable to improve upon even the lower mass selectivity of the multipole ion guide.

In some embodiments of the present invention, quadrupole 300 of FIG. 3 functions as a multipole mass filter. In such a mass filter, the applied potential has non-zero DC and AC potential components concurrently applied to the electrodes. In multipole mass filters, in contrast to multipole ion guides described above, only a relatively narrow range of ion masses can achieve stable trajectories within the multipole device. As a result, this narrow range of ion masses is thereby selected for conduction by the multipole mass filter.

In an exemplary apparatus of the present invention, the apparatus includes a RFIG in ion communication with an ion source. The RFIG is a multipole ion guide having properties similar to ion guide 300 depicted in FIG. 3. The ion source includes systems or methods for the electrostatic extraction of ion therefrom, similar to ion source 200 depicted in FIG. 2. As described in further detail below, both the ion source and the ion transmission device of this exemplary apparatus exhibit mass-dependent behavior that may result in selective transmission of the affected ion population. Previous methods and apparatus were significantly limited in their ability to remedy this problem. In contrast, methods and apparatus of the present invention provide improvement and advantages over these earlier approaches.

As a result of this mass-dependent behavior of the RFIG, the population of ions in the ion current exiting the ion transmission device may be less diverse and have lower partial ion currents than the ion population that enters the device. In certain applications of the present invention, such as time-of-flight mass analysis, this diminishment of the ion current may have considerable impact on the mass analysis results. For example, a poorer partial ion current may result in a lower TOF signal.

The foregoing limitation may be partially addressed by “ramping” one or more appropriate parameters of the ion transmission device. In this technique, different sets of operating parameters are applied to the RFIG in sequence. For example, an AC potential having a peak amplitude of Φ_{AC}_{_{—}}₁ is applied to the RFIG over a first period of time. Following this first period, a peak amplitude of Φ_{AC}_{_{—}}₂ is applied in a second period. Other additional intervals in which different operating parameters are applied to the RFIG may follow in a like manner. In each interval, a different range of ion masses may be stably conducted by the RFIG. By allowing the RFIG to operate under multiple operating parameters, the RFIG may cumulatively conduct a broader range of ion masses than would be possible under a single set of operating parameters. As a result, the cumulative ion current of the ion transmission device may be improved accordingly.

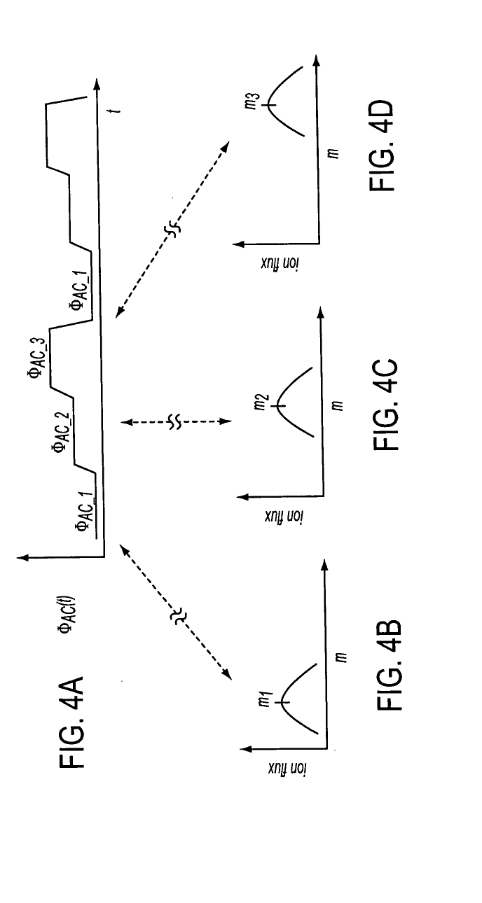

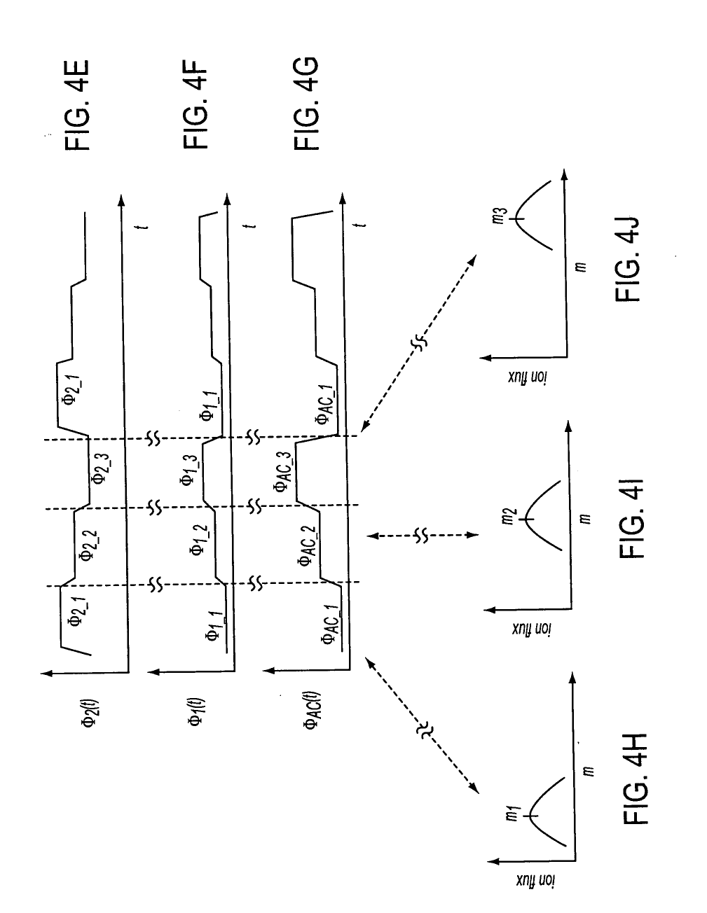

FIGS. 4A-D illustrate, in principle, a prophetic example of mass selectivity in a representative RFIG of the present invention. In this example, the distributions of ion masses (i.e., m₁, m₂, and m₃) that are conducted by the RFIG at three different peak AC amplitudes (i.e., Φ_{AC}_{_{—}}₁, Φ_{AC}_{_{—}}₂, and Φ_{AC}_{_{—}}₃) are shown. In FIG. 4A, an exemplary time-course of the peak AC amplitude as applied to an RFIG is shown. In a first time interval, when the peak AC amplitude is Φ_{AC}_{_{—}}₁, the RFIG conducts a mass range of ions distributed around mass m₁, as shown in FIG. 4B. Likewise in FIG. 4C, when the RFIG is ramped to Φ_{AC}_{_{—}}₂ during a second time interval, a different mass range, now centered around mass m₂, is preferably conducted. At a third time interval, the peak AC amplitude of Φ_{AC}_{_{—}}₃ results in the conduction of the mass range m₃ as shown in FIG. 4D. Repeating this ramping cycle, such as by reapplication of the Φ_{AC}_{_{—}}₁ peak amplitude to the RFIG, results again in conduction of mass range m₁. As a result, there is no single set of ion guide operating parameters, such as a value for Φ_{AC}, at which the RFIG can conduct efficiently the entire range of ion masses that are shown in FIGS. 4B-4D.

However, certain heretofore unaddressed shortcomings remain despite the use of ramping. Most significantly, ramping the ion transmission device may not improve partial ion currents if the precedent ion source providing the ions is the limiting factor. For example, if the preceding ion source provides only a narrow range of ion masses to the ion transmission device, ramping the RFIG to allow conduction of ions outside of this narrow range will not result in improved ion current for that mass range.

Moreover, the above limitation of the ion source is particularly apparent because of the demonstrated mass dependence of ion sources. For example, in ion sources in which ions are extracted electrostatically, ions are not extracted with uniform efficiency. Other ion sources may also demonstrate such mass dependence and therefore behave in a similar manner. An example of this ion source behavior is described below.

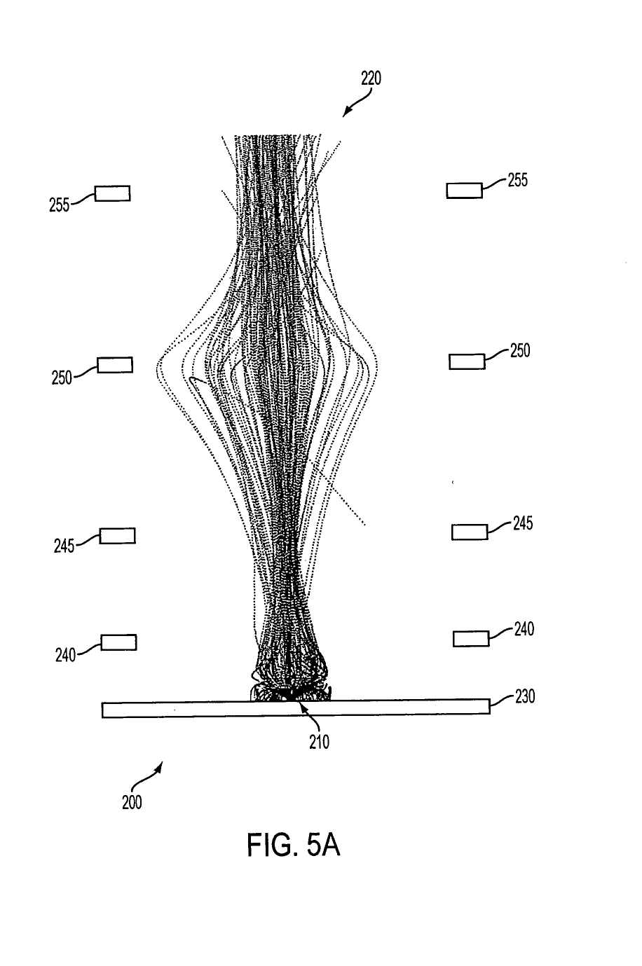

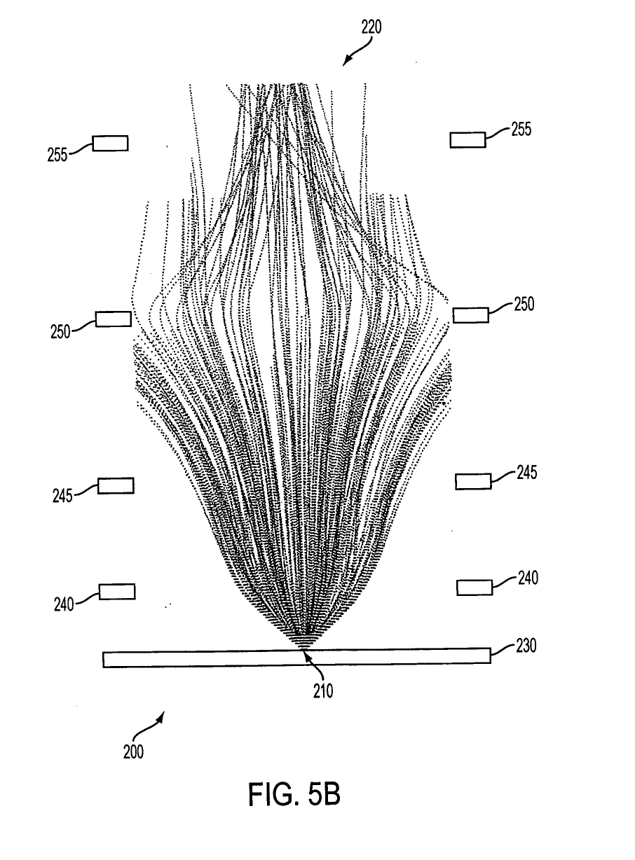

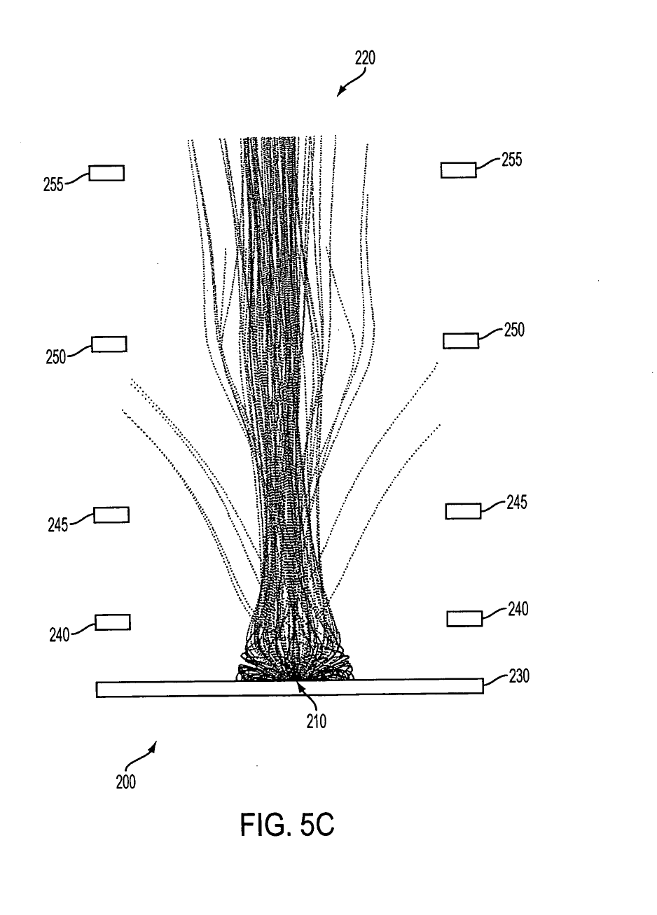

Referring to FIGS. 5A-5C, an exemplary ion source of the present invention is depicted. Ion source 200 (as described above in relation to FIG. 2) includes electrodes 230-255. Ions are generated at introduction point 210 and are intended to exit via ion exit 220 in order to proceed to subsequent devices. In certain embodiments of the present invention, an ion transmission device including a RFIG may be positioned to receive ions exiting the ion source.

Each of FIGS. 5A-5C depicts simulated ion trajectories within the ion source of the present invention. For the ion source in each figure, a set of operating parameters have been applied to the ion source, specifically a set of DC potentials that have been applied to each of the ion source electrodes. Under these conditions, a plurality of ions are introduced at approximately introduction point 210 and, as a result, undergo deflection and other accelerations subject to the imposed electric field and, if present, collisions with a background gas. In this stochastic model, the efficiency of ion extraction at ion exit 220 can be assessed based on the number of simulated ion trajectories that exit successfully via ion exit 220.

The simulation depicted in FIGS. 5A-5C were performed using methods such as those described in the following references: Andreas Hieke, “GEMIOS—a 64-Bit multi-physics Gas and Electromagnetic Ion Optical Simulator”, Proceedings of the 51st Conference on Mass Spectrometry and Allied Topics (Jun. 8- 12 2003, Montréal, PQ, Canada); Andreas Hieke “Theoretical and Implementational Aspects of an Advanced 3D Gas and Electromagnetic Ion Optical Simulator Interfacing with ANSYS Multiphysics”, Proceedings of the International Congress on FEM Technology, pp. 1.6.13 (Nov. 12-14 2003, Potsdam, Germany); Andreas Hieke, “Development of an Advanced Simulation System for the Analysis of Particle Dynamics in LASER based Protein Ion Sources”, Proceedings of the 2004 NSTI Nanotechnology Conference and Trade Show Nanotech 2004 (Mar. 7-11, 2004, Boston, Mass., U.S.A). Other suitable programs, algorithms, methods, and the like that are known in the art may also be used to perform simulations such as those described herein.

As set forth in Table 1, the simulation was conducted with the listed potential values applied to the corresponding electrodes, while simulating the trajectories of ions having the listed mass.

TABLE I

| | | | | | | |
|---|---|---|---|---|---|---|
| Ion Mass m | 1000 | u | 10000 | u | 10000 | u |
| Potential Φ on | 40 | V | 40 | V | 70 | V |
| Electrode 230 | | | | | | |
| Potential Φ on | 52 | V | 52 | V | 122 | V |
| Electrodes 240 | | | | | | |
| Potential Φ on | 0 | V | 0 | V | 0 | V |
| Electrodes 245 | | | | | | |
| Potential Φ on | 40 | V | 40 | V | 70 | V |
| Electrodes 250 | | | | | | |
| Potential Φ on | 0 | V | 0 | V | 0 | V |
| Electrodes 255 | | | | | | |

FIGS. 5A and 5B both depict ion source 200 under the same electrostatic and pneumatic conditions, as shown in Table 1. However, each of these figures illustrates the trajectories of a different ionic species. In FIG. 5A, trajectories of ions having mass m=1000 u are shown. In FIG. 5B, trajectories of ions having mass m=10000 u are shown.

Referring to FIG. 5A, under the operating parameters listed in Table 1, the simulation predicts that nearly all of the ions having mass of 1000 u are expected to exit the ion source at exit 220. In contrast, FIG. 5B depicts that under the same set of operating parameters the ions having a mass of 10000 u are extracted with a significantly lower efficiency. Therefore, under these operational conditions, if a diverse population of ions of varying mass were introduced into ion source 200, those having mass 1000 u are more efficiently extracted than those of mass 10000 u).

As a result of this mass-dependent efficiency of ion extraction at the ion source, such differences may be propagated to later components, such as an RFIG in an ion transmission device. Accordingly, the partial ion current of the heavier ions (i.e., those around 10000 u) is expected to be lower than that of the lighter ions (i.e., those around 1000 u). Furthermore, because this difference originates in the ion source, ramping or otherwise changing the operating parameters of the subsequent RFIG may not significantly improve the partial current.

However, the simulations reveals a different result in FIG. 5C. In this figure, a different set of DC potentials have been applied to ion source 200. Under this different set of operating parameters, ions having a mass of 10000 u are now extracted with a much greater efficiency. These simulations demonstrate that these and other ion sources exhibit a mass dependency during ion extraction. Therefore, if ions of a particular mass range are desired, the yield of such ions can be improved by changing the operating parameters of the ion source.

However, despite this mass dependency of the ion source, ion source operating parameters were not previously changed during its operation of the apparatus. Instead, the operating parameters that were applied to the ion source were maintained regardless of the ion current and the operating parameters of the subsequent ion transmission device. As is evident from the examples provided in. FIGS. 5A-5C, no single set of operating parameters of the ion source is suitable for all ion masses.

Therefore, even if the RFIG of the ion transmission device were ramped to cover a broader mass range, such practices were not completely effective because the ion source was often not providing ions of suitable masses.

The methods and apparatus of the present invention solves these and other problems. By coordinating the respective operating parameters of both the ion source and the ion transmission device, the present invention may ensure that the ions provided by the ion source are commensurate with the ions conducted by the ion transmission device.

For example, a RFIG included in an ion transmission device of the present invention is configured with operating parameters such that it preferentially conduct ions of a particular mass range. In accordance with the present invention, this set of RFIG operating parameters is coordinated with a set of corresponding operating parameters that are applied to the ion source. As a result of this coordination, the ion source is configured to efficiently extract and thereby provide ions having substantially the same particular mass range as those preferentially conducted by the RFIG. This coordination, therefore, may result in a significantly improved ion current for the particular mass range of ions.

In a further example in accordance with the present invention, a different set of operating parameters may now be applied to the RFIG, thereby resulting in the preferential conduction of a different mass of ions. Such changes occur during the practice of ramping, as described above. To maintain coordination in accordance with the present invention, a second set of operating parameters is now applied to the ion source, whereby the second set corresponds to the second set applied to the RFIG. Under this second set of operating parameters, the ion guide may now provide a different mass range of ions that matches those now being conducted by the RFIG.

Therefore, the present invention provides a significant improvement to the practice of ramping the RFIG of an ion transmission device. For example, at each ramping interval of the RFIG, the ion source may be correspondingly reconfigured with applied operating parameters such that the masses or other characteristics of the ions provided by the ion source match those that are to be conducted by the RFIG. This method of the present invention may therefore increase the ion current over a broad range of masses, particularly when compared to ramping the RFIG alone.

An example of coordinating the operating parameters of different components, in accordance with the present invention, is depicted in FIGS. 4E-4J. FIGS. 4E-4J illustrate, in principle, an prophetic example of coordination of a RFIG and an ion source, in conjunction with a prophetic example of resulting mass selectivity. In the example of FIG. 4G-4J, as described above in relation to FIGS. 4A-4D, the distributions of ion masses (i.e., m₁, m₂, and m₃) that are conducted by the RFIG at three different peak AC amplitudes (i.e., Φ_{AC}_{_{—}}₁, Φ_{AC}_{_{—}}₂, and Φ_{AC}_{_{—}}₃) are shown. FIG. 4G shows an exemplary time-course of the peak AC amplitude as applied to an RFIG. FIGS. 4E and 4F show concurrent time-courses of representative DC potentials (i.e., Φ₁ and Φ₂) applied respectively to two discrete electrodes within an ion source. In accordance with the present invention, the potentials applied to each of the ion source electrodes (as shown in FIGS. 4E and 4F) are coordinated with the ramping of the RFIG (as shown in FIG. 4G). In this example, when Φ_{AC}_{_{—}}₁ is applied to the RFIG as shown in FIG. 4G, ion source electrodes are coordinated accordingly by the application of DC potentials Φ₁_{_{—}}₁ and Φ₂_{_{—}}₁, as respectively depicted in FIGS. 4E and 4F. In some embodiments, as described herein, the operating parameter values used in this coordination may be predetermined. In each following time interval, the change in Φ_{AC} resulting from the ramping of the RFIG (as in FIG. 4G) is coordinated by changes to Φ₁ and Φ₂ (FIGS. 4F and 4G, respectively) in the respective ion source electrodes. This exemplary coordination may result in improved ion current for the mass range that are preferably conducted by the RFIG at each time interval.

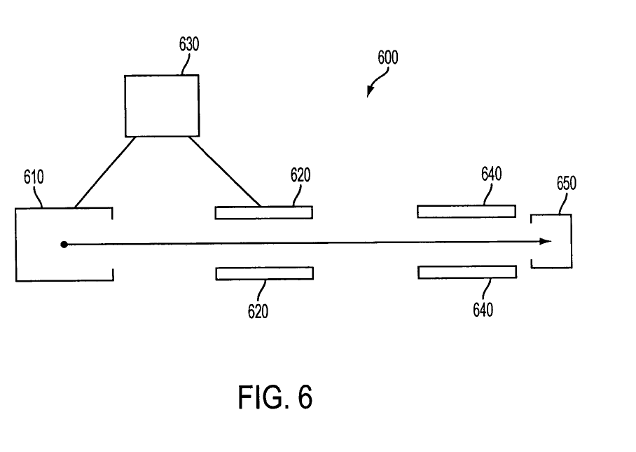

An example apparatus of the present invention is depicted in FIG. 6. Apparatus 600 includes ion source 610, RFIG 620, mass analyzer 640, ion detector 650, and controller 630. The ion source, the RFIG, the mass analyzer, and the ion detector are in sequential ion communication. In certain embodiments of the present invention, mass analyzer 640 may include any suitable mass analyzer, such as a quadrupole mass filter, a reflectron, a time-of-flight mass analyzer, an electric sector time-of-flight mass analyzer, a triple quadrupole apparatus, a Fourier transform ion cyclotron resonance mass analyzer, a magnetic sector mass analyzer, or other suitable mass analyzers known in the art.

Mass analyzer 640 may also be any suitable TOF apparatus known in the art, such as an electric sector TOF apparatus, a multi-electric sector TOF apparatus (such as a quadruple electric sector TOF apparatus), a reflectron, and other known TOF mass analyzers and suitable combinations thereof. RFIG 620 may include any known multipole ion guide known in the art, including quadrupoles, hexapoles, octopoles, and the like. Alternatively, or in addition, RFIG 620 may also include other suitable devices in serial ion communication with the RFIG, such as collision cells, electrostatic lenses, and the like. In some embodiments of the present invention, apparatus 600, like apparatus 100 of FIG. 1, may be a single-stage mass spectrometer apparatus, in which RFIG 620 serves as an ion guide without performing mass analysis.

In some other embodiments of the present invention, apparatus 600, like apparatus 100 of FIG. 1, may be a tandem mass spectrometer, whereby apparatus 600 comprises two or more mass analyzers. In some of such tandem mass spectrometer embodiments of the present invention, mass analyzer 640 of apparatus 600 may include a tandem mass analyzer. For example, mass analyzer 640 can be selected from the group consisting of a quadrupole-TOF MS, an ion trap MS, an ion trap TOF MS, a TOF-TOF MS, a Fourier transform ion cyclotron resonance MS, with an orthogonal acceleration quadrupole-TOF MS a particularly useful embodiment.

In other tandem mass spectrometer embodiments of the present invention, both RFIG 620 and mass analyzer 640 may each include one or more mass analyzers. For example, RFIG 620 may include a first mass analyzer and mass analyzer 640 may include a second mass analyzer. In some of such embodiments, the first mass analyzer also serves to function as an ion transmission device of RFIG 620.

In other of such embodiments, RFIG 620 further includes one or more mass analyzers and one or more ion guides, whereby said mass analyzers and ion guides function together as RFIG 620. For example, RFIG 620 may include a RFIG in serial communication with a quadrupole mass filter, an ion trap, or other mass analyzers as are known in the art. Alternatively, or in addition, in some embodiments mass analyzer 640 may include more than one mass analyzer components situated in tandem. A suitable tandem mass spectrometer can be selected from the group consisting of a quadrupole-TOF MS, an ion trap MS, an ion trap TOF MS, a TOF-TOF MS, a Fourier transform ion cyclotron resonance MS, with an orthogonal acceleration quadrupole-TOF MS a particularly useful embodiment.

Ion detector 650 which may include systems or methods for detecting ions and amplifying their signals that are known in the art. For example, ion detector 650 may include continuous electron multipliers, discrete dynode electron multipliers, scintillation counters, Faraday cups, photomultiplier tubes, and the like. Ion detector 650 may also include systems or methods for recording ions detected therein, such as a computer or other electronic apparatus

Controller 630 is in signal communication with ion source 610 and RFIG 620. In this example, controller 630 is configured to determine one or more of the operating parameters of RFIG 620 and apply one or more of the operating parameters to ion source 610. In this exemplary embodiment, controller 610 determines, for example, the peak amplitude of the AC potential applied to RFIG 620. This set of operating parameters is thus coordinated with that of the ion source by applying a corresponding set of operation parameters to the ion source including, for example, one or more DC potentials applied to its electrodes.

As described above, other conceivable controller configurations are envisioned to be within the scope of the present invention. For example, controller 630 may also be configured to determine one or more of the operating parameters of ion source 610, as well as apply one or more of the operating parameters to RFIG 620.

In some embodiments, controller 630 may include a digital computer, a microprocessor, and memory storage. In some embodiments, the memory storage may be used to store values for operating parameters, including predetermined values used in coordination. In some embodiments, controller 630 may also include a plurality of such computers, wherein at least one computer is in communication with ion source 610 and at least one other computer is in communication with ion transmission device 620. In some embodiments, one or more of these separately communicating computers may be in communication with each other.

Following this determination of the peak amplitude of the AC potential applied to RFIG 620, controller 630 may coordinate the operating parameters of ion source 610 with that of the RFIG. For example, the controller may coordinate the DC potentials applied to the electrodes of the ion source with the peak AC amplitude on the RFIG. Such coordination may also involve calculation of one or more values for operational parameters based on other operating parameters that have been determine or measured.

In some embodiments, controller 630 may calculate the appropriate ion source operating parameters, use predetermined operating parameters, or suitable combinations thereof. In addition, predetermined operating parameters of ion source 610 may be derived from empirical observations, experimental determinations, computer-based simulations, mathematical calculations, and other suitable methods and combinations thereof.

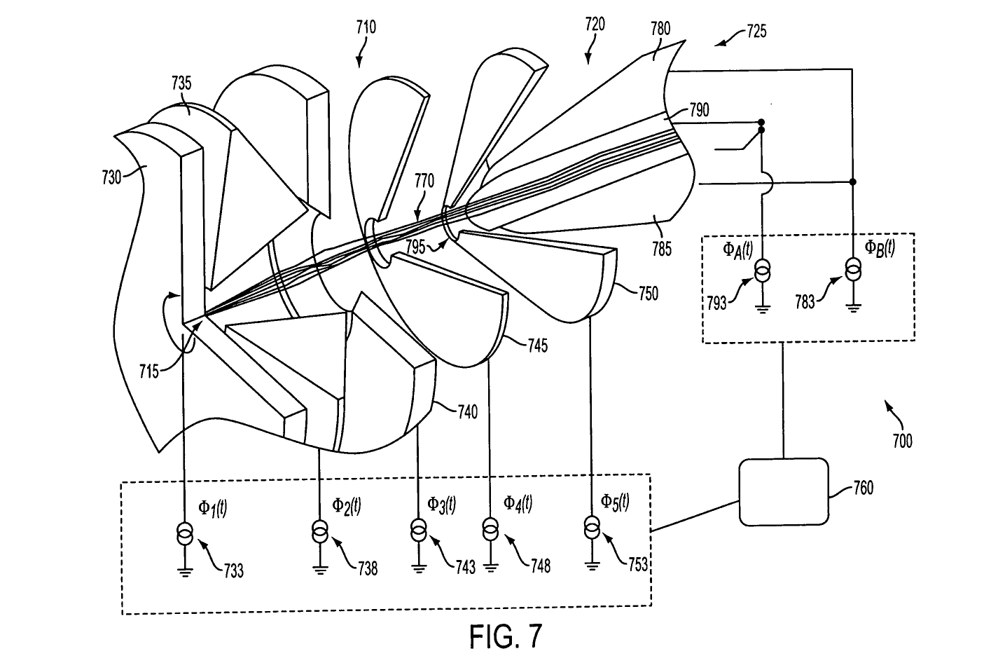

Referring to FIG. 7, a perspective cut-away view of a preferred embodiment of the present invention is depicted. Apparatus 700 of the present invention includes ion source 710, in which mobile ions are generated. Ion source 710 may include any suitable systems or methods for generating ions known in the art, including those described hereinabove with respect to ion sources 110, 200, and 610. In the configuration depicted in FIG. 7, ions are preferably introduced into or generated in the ion source at a location substantially near ion generation point 715. For example, ion generation point 715 may represent the point at which laser desorption/ionization occurs in suitable ion sources.

Ion source 710 further comprises basal electrode 730 and axisymmetric electrodes 735, 740, 745, and 750. Voltage potentials may be applied to some or all of these electrodes. The electric field resulting from these electrodes may affect the potentials experienced by the ions within the ion source. For example, potentials may be applied to the electrodes of ion source 710 in a manner such that ions are accelerated and deflected towards ion source exit 795. Voltage potentials on each of the ion source electrodes are applied by potential sources 733, 738, 743, 748, and 753 in the manner depicted. The foregoing potential sources may apply DC potentials, AC potentials, or any other arbitrarily time-dependent waveform or suitable combinations thereof to their respective electrodes.

Apparatus 700 also includes ion transmission device 720 suitable for conducting mobile ions extracted and received from ion source 710 via ion source exit 795. In the preferred embodiment depicted in FIG. 7, ion transmission device 720 includes quadrupole radio-frequency ion guide 725, for which three of its electrodes are depicted (electrodes 780, 785, and 790). The fourth electrode has been omitted for purposes of clarity. Electrodes 780 and 785 are paired such that potential source 783 applies a common potential to both electrodes. Similarly, electrode 790 and the omitted electrode are commonly served by potential source 793.

In accordance with the preferred invention, the respective operating parameters of ion source 710 and ion transmission device 720 are coordinated in order to effect control of the ion current. Such coordination may be performed by controller 760 in signal communication with one or more of the potential sources as shown.

In an example, ions may be generated in ion source 710 at ion generation point 715. Application of a given set of operating parameters to electrodes 730, 735, 740, 745, and 750 can result in acceleration and extraction of ions of a given mass range towards ion source exit 795. Ions that exit in this manner can therefore enter multipole RFIG 725 of ion transmission device 720. Ion transmission device 720, having operating parameters that are coordinated with those of ion source 710, is configured to conduct ions having approximately the same or overlapping mass range. Accordingly, such ions are thereby conducted through multipole RFIG. Exemplary simulated ion trajectories within the ion source and the ion transmission device, as indicated by reference numeral 770, are depicted.

In some embodiments, ion source 710 may use superposed electrostatic and gas flow fields, as further described and claimed in the commonly owned patent application filed concurrently herewith by Andreas Hieke, entitled “Ion Source With Controlled Superposition Of Electrostatic And Gas Flow Fields” (attorney docket number CiphBio-16), the disclosure of which is incorporated herein by reference in its entirety.

In another aspect of the present invention, existing apparatus may be upgraded, retrofitted, or otherwise modified in accordance with the methods and apparatus of the present invention. For example, a prior or existing apparatus may lack a controller suitable for coordinating the ion source and the ion transmission device. Accordingly, it is envisioned that installing such a suitably configured controller would provide an apparatus in accordance with the present invention.

In another embodiment, an existing apparatus may have a controller that is not configured for coordination operating parameters. In accordance with the present invention, this existing apparatus may thus be properly configured such that it is able to conduct configurations of operating parameters in the manner described above.

All patents, patent publications, and other published references mentioned herein are hereby incorporated by reference in their entireties as if each had been individually and specifically incorporated by reference herein. By their citation of various references in this document, applicants do not admit that any particular reference is “prior art” to their invention.

While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined not with reference to the above description, but instead should be determined with reference to the appended claims along with their full scope of equivalents.

1. A method for controlling the ion current of an ion transmission device, wherein an ion source is in ion communication with and provides ions to the ion transmission device, the method comprising:
coordinating a value for each of at least one operating parameter of the ion source with a value for each of at least one operating parameter of the ion transmission device.

2. The method of claim 1, wherein the step of coordinating comprises setting the value for each of the at least one ion source operating parameters, wherein each said value is predetermined for each of the at least one ion source operating parameter.

3. The method of claim 2, wherein the predetermined value for each of the at least one ion source operating parameter is such that the ion source, when set with each said predetermined value, provides an increased amount of ions of a given mass range to the ion transmission device compared with the amount of ions of the given mass range provided when the respective operating parameters are not coordinated.

4. The method of claim 2, wherein the predetermined value for each of the at least one ion source operating parameter is such that the ion source, when set with each said predetermined value, provides an increased amount of ions of all mass ranges to the ion transmission device compared with the amount of ions of all mass ranges provided when the respective operating parameters are not coordinated.

5. The method of claim 1, wherein the ion transmission device provides ions to a mass spectrometer, an ion mobility spectrometer, or a total ion current measuring device.

6. The method of claim 1, wherein the step of coordinating comprises:
setting a value for each of the at least one ion transmission device operating parameter, wherein the values set for each of the at least one ion transmission device operating parameter is predetermined for a given mass range of ions; and
setting a value for each of the at least one ion source operating parameter, wherein the values set for each of the at least one ion source operating parameter is predetermined for the given mass range of ions.

7. The method of claim 1, wherein the step of coordinating comprises:
setting a first set of values for the at least one ion transmission device operating parameter; and
setting a first set of values for the at least one ion source operating parameter,
wherein the first set of values for the at least one ion source operating parameter is predetermined based on the first set of values for the at least one ion transmission device operating parameters.

8. The method of claim 1, wherein the step of coordinating comprises:
determining a value for each of the at least one ion transmission device operating parameter; and
setting a value for each of the at least the ion source operating parameters,
wherein the value set for each of the at least one ion source operating parameter is based on the value determined for each of the at least one ion transmission device operating parameter, and
wherein the value for each of the at least one ion source operating parameter is predetermined.

9. The method of claim 1, wherein the step of coordinating comprises:
setting the value for each of the at least one ion transmission device operating parameter; and
setting the value for each of the at least one ion source operating parameter,
wherein at least one of the values set for the ion source operating parameters is calculated based on at least one of the values set for ion transmission guide operating parameters.

10. The method of claim 1, wherein the ion source and the ion transmission device are in signal communication with a controller, the step of coordinating comprising:
setting with the controller at least one of the values of the at least one ion source operating parameter,
wherein the values of the ion source operating parameters set by the controller are predetermined for a given ion mass range.

11. The method of claim 1, wherein the ion source and the ion transmission device are in signal communication with a controller, the step of coordinating comprising:
setting with the controller at least one of the values of the at least one ion source operating parameter,
wherein at least one the values of the ion source operating parameters set by the controller is calculated based on at least one of the values of the at least one ion transmission device operating parameter.

12. The method of claim 1, wherein the ion transmission device comprises a multipole radio-frequency ion guide, and the at least one ion transmission guide operating parameter includes the peak amplitude and/or the frequency of the radio-frequency alternating current potential of at least one of the multipole ion guide electrodes.

13. The method of claim 1, wherein the ion source comprises at least one electrode, and the at least one ion source operating parameter includes the potential applied to at least one of the electrodes of the ion source.

14. The method of claim 1, wherein the ion source comprises a laser desorption/ionization ion source, a chemical ionization ion source, an electron impact ionization ion source, a photoionization ion source, an electrospray ionization ion source, or a plasma desorption ion source.

15. The method of claim 1, wherein the ion source comprises a gas flow field superposed on an electric field of the ion source.

16. An apparatus comprising:
an ion source;
an ion transmission device in ion communication with the ion source; and
a controller configured to coordinate the value of at least one ion source operating parameter with the value of at least one ion transmission device operating parameter.

17. The apparatus of claim 16, wherein the controller comprises a digital computer and memory.

18. The apparatus of claim 16, wherein the controller is in signal communication with the ion source and the ion transmission device.

19. The apparatus of claim 16, wherein the controller, when coordinating the respective values of the ion source and ion transmission device operating parameters, is configured to:
determine at least one of the values of the at least one ion transmission device operating parameter; and
set at least one of the values of the at least one ion source operating parameter,
wherein the values set for the ion source operating parameters are predetermined and based on at least one of the values determined for the at least one ion transmission device operating parameter.

20. The apparatus of claim 16, wherein the controller comprises memory and the predetermined ion source operating parameter values are stored in the memory.

21. The apparatus of claim 19, wherein the controller, when setting the values of the at least one ion source operating parameter, is configured to:
calculate at least one of the values of the at least ion source operating parameter,
wherein said calculation is based on at least one of the values determined for the at least one ion transmission device operating parameter.

22. The apparatus of claim 16, wherein the controller, when coordinating the respective values of the ion source and ion transmission device operating parameters, is configured to:
set at least one of the values of the at least one ion transmission device operating parameter; and
set at least one of the values of the at least one ion source operating parameter,
wherein the values set for the at least one ion source operating parameter are predetermined for a given mass range of ions, such that ions of the given mass range are provided from the ion source to the ion transmission device.

23. The apparatus of claim 16, wherein the ion source comprises at least one electrode that affects the potential experienced by ions in the ion source.

24. The apparatus of claim 23, wherein the at least one ion source operating parameter includes the magnitude of a direct current potential of at least one of the ion source electrodes.

25. The apparatus of claim 16, wherein the ion transmission device comprises a multipole radio-frequency ion guide.

26. The apparatus of claim 25, wherein the at least one ion transmission device operating parameter includes the amplitude of a radio-frequency alternating current potential of at least one of the multipole radio-frequency ion guide electrodes.

27. The apparatus of claim 25 or claim 26, wherein the multipole radio-frequency ion guide comprises a quadrupole ion guide, a hexapole ion guide, or an octopole ion guide.

28. The apparatus of claim 16 further comprising a mass analyzer in ion communication with the ion transmission device.

29. The apparatus of clam 28, wherein the mass analyzer comprises a quadrupole mass filter, a reflectron, a time-of-flight mass analyzer, an electric sector time-of-flight mass analyzer, a triple quadrupole apparatus, a Fourier transform ion cyclotron resonance mass analyzer, or a magnetic sector mass analyzer.

30. The apparatus of claims 16, wherein the ion source comprises a laser desorption/ionization ion source, a chemical ionization ion source, an electron impact ionization ion source, a photoionization ion source, an electrospray ionization ion source, or a plasma desorption ion source.

31. The apparatus of claim 16, wherein the ion source includes a gas flow field superposed on the electric field of the ion source.

32. A tandem mass spectrometer comprising:
the apparatus of claim 16;
a first mass analyzer in ion communication with said apparatus;
and a second mass analyzer in ion communication with the first mass analyzer.

33. The tandem mass spectrometer of claim 32 further comprising an ion detector.

34. The tandem mass spectrometer of claim 33, wherein the first mass analyzer and the second mass analyzer each comprises a quadrupole mass filter, a reflectron, a time-of-flight mass analyzer, an electric sector time-of-flight mass analyzer, a triple quadrupole apparatus, a Fourier transform ion cyclotron resonance mass analyzer, or a magnetic sector mass analyzer.

35. The tandem mass spectrometer of claim 32, wherein the ion source comprises a laser desorption/ionization ion source, a chemical ionization ion source, an electron impact ionization ion source, a photoionization ion source, an electrospray ionization ion source, or a plasma desorption ion source.

36. The tandem apparatus of claim 32, wherein the ion source includes a gas flow field superposed on the electric field of the ion source.
